(19) United States
(12) Patent Application Publication
(10) Pub. No.: US 2024/0429372 A1
(43) Pub. Date: Dec. 26, 2024

(54) Cathode Active Material For Lithium-Ion Battery And Method For Preparing Said Active Material, And Cathode Comprising Said Active Material And Method For Preparing Said Cathode

(71) Applicant: Vidyasirimedhi Institute of Science and Technology (VISTEC), Rayong (TH)

(72) Inventors: Montree Sawangphruk, Bangkok (TH); Nichakam Anansuksawat, Samut Sakhon (TH); Farkfun Duriyasart, Nonthaburi (TH); Poramane Chiochan, Bangkok (TH); Nutthaphon Phattharasupakun, Nonthaburi (TH); Chanikam Tomon, Bangkok (TH); Sangchai Sarawutanukul, Bangkok (TH); Salatan Duangdangchote, Nonthaburi (TH); Nattanon Joraleechanchai, Nakhon Ratchasima (TH); Worapol Tejangkura, Bangkok (TH); Chonticha Jangsan, Maha Sarakham (TH)

(21) Appl. No.: 18/700,871

(22) PCT Filed: Dec. 21, 2021
(86) PCT No.: PCT/IB2021/062058

§ 371 Date: Apr. 12, 2024

(30) Foreign Application Priority Data
Oct. 15, 2021 (TH) 2101006502

(51) Int. Cl. H01M 4/36; H01M 4/02; H01M 4/04; H01M 4/131; H01M 4/1397; H01M 4/505; H01M 4/525; H01M 4/58; H01M 4/62; H01M 4/66; H01M 10/0525; H01M 10/0569; H01M 50/107

(52) U.S. Cl. CPC H01M 4/366; H01M 4/0404; H01M 4/0471; H01M 4/131; H01M 4/1397; H01M 4/505; H01M 4/525; H01M 4/5825; H01M 4/623; H01M 4/625; H01M 4/661; H01M 10/0525; H01M 10/0569; H01M 50/107; H01M 2004/027; H01M 2004/028; H01M 2300/0034; H01M 2300/0037; H01M 2300/0051

(57) ABSTRACT

The present invention relates to a cathode active material for a lithium-ion battery having a structure comprising a core and a shell, wherein the core comprises lithium nickel manganese cobalt oxide compound and the shell comprises any one of or a mixture of materials selected from a carbon material, a reduced graphene oxide, a metal oxide, and a lithium-containing composite in an appropriate specified amount. Further, the invention relates to a method for preparing said cathode active material, a battery cathode comprising the active material according to the invention and a method for preparing said cathode, and a battery comprising said cathode. The lithium-ion battery containing the cathode comprising the active material according to the present invention has improved stability, capacity, and cycle life, thus enabling more efficient industrial applications.

### TECHNICAL FIELD

Chemical technology related to a cathode active material for a lithium-ion battery and a method for preparing said active material, and a cathode comprising said active material and a method for preparing said cathode

### BACKGROUND OF THE INVENTION

The development of battery industry is considered a key for the development of technology at present due to the leap development of electronics technology and the development of electric vehicle industry. Lithium-ion battery (Li-ion battery) currently receives vast attention as it can be used at a much higher voltage than nickel-cadmium battery (Ni—Cd battery) or nickel-metal hydride battery (Ni-MH battery). Moreover, the lithium-ion battery provides high energy density per weight and capacity, compared to other types of battery.

The main components which affect the overall efficiency of the lithium-ion battery are the cathode, anode, separator, and electrolyte solution, particularly metal oxide compound used to produce the cathode since the compound used to make the cathode needs to serve as a network for lithium ions to enter and leave.

Metal oxide compound generally used to make the cathode can be classified based on its structure, e.g., layer structure, spinel structure or olivine structure. Among these structures, the layer structure has the highest lithium-ion storage capacity, thus providing higher capacity than other structures. Energy storage materials with a highly-efficient layer structure that are used commercially are a lithium nickel cobalt aluminium oxide (NCA) material having a general formula Liₓ(Ni_{y}Co_{z}Al_{1-y-z})O₂ and a lithium nickel manganese cobalt oxide (NMC) material having a general formula Liₓ(Ni_{y}Mn_{z}Co_{1-y-z})O₂, whereby 0<x, y, z<1, particularly the NMC material with a mole ratio of Ni:Mn:Co of 8:1:1 (NMC 811) which offers high capacity and has reasonable price for the industrial-scale production as it contains a low ratio of cobalt, which is an expensive material.

However, when contacted with the electrolyte solution for a long time or upon several application cycles, the NMC material reacts with the electrolyte solution and its layer structure R(-)3m transforms into a spinel structure Fd(-)3m and eventually becomes a rock salt structure Fm(-)3m, which is difficult to reverse, thus resulting in a loss of energy storage capacity. Moreover, upon several application cycles, the NMC material may experience a reduction of Ni⁴⁺ to Ni²⁺. Ni²⁺ has a size similar to lithium ion which causes lithium ion to be replaced with Ni²⁺, resulting in a cation mixing which leads to a loss of lithium storage space. The reduction can also result in an oxygen release, which is the main cause of an explosion. This phenomenon is called “thermal runaway”.

As a result, there is an attempt to develop battery component materials to overcome the aforementioned problems, particularly a development of the cathode active material which is non-reactive to the electrolyte solution. Examples of prior arts are as follows.

US 2016/0351973 A1 discloses a nano-engineered coating for cathode active materials, anode active materials, and solid-state electrolyte materials by coating alumina oxide (Al₂O₃) and titanium dioxide (TiO₂) on an NMC 811 material using an atomic layer deposition technique. The test result shows that the alumina oxide coating can increase the capacity by 8% at ⅓ C current. It also increases the stability and the capacity retention, compared to a conventional NMC 811 material.

However, alumina oxide and titanium dioxide have low conductivity, the battery capacity therefore is not as high as it should be. In addition, the coating using the atomic layer deposition technique is complicated and requires a control of many variants and is thus not suitable for industrial applications.

WO 2015/132647 A1 discloses lithium metal oxide powder used as a cathode material for a rechargeable battery. An energy storage NMC material with a ratio of Ni to Mn to Co of 4:3:3 (NMC 433) is coated with zirconium-doped alumina oxide (Zr-doped Al₂O₃). It was found that coating alumina oxide alone on an NMC 433 material increases the capacity retention. However, the battery capacity was decreased as alumina oxide increases the battery resistance. Moreover, it was found that mixing alumina oxide with zirconium provides higher capacity but still lower than that of a conventional NMC 433 material.

WO 2010/053222 A1 discloses a cathode active material for a lithium secondary battery which includes lithium metal oxide secondary particle core formed by lithium metal oxide particle core and a shell formed by coating such core with barium titanate and metal oxide using a dry coating method. The test result shows that a conventional NMC material and an NMC material coated with a mixture of barium titanate, titanium oxide, and ferric phosphate lithium oxide have the same capacity of about 155 mAh/g. After being subjected to a safety test, the battery using the conventional NMC material was found to catch fire, whereas the NMC material coated with the oxide mixture did not catch fire.

The above prior arts illustrate the attempt to improve the stability and increase the battery cycle life by encapsulating the energy storage material with different materials. However, those prior arts still have limitations as the shells used for encapsulation have low conductivity or high resistance, the capacity obtained is therefore decreased or not as high as it should be.

Accordingly, there is a need for a development of structure and materials for the battery cathode which have high conductivity and low resistance which can prevent a reaction with electrolyte solution to obtain a battery with higher capacity and increased stability and cycle number.

### SUMMARY OF THE INVENTION

In the first aspect, the present invention relates to a cathode active material for a lithium-ion battery having a structure comprising a core and a shell, wherein the core comprises lithium nickel manganese cobalt oxide compound and the shell comprises any one of or a mixture of materials selected from
a carbon material in an amount of 0.1-1 part by mass based on the total shell mass,
a reduced graphene oxide in an amount of 0.1-1 part by mass based on the total shell mass,
a metal oxide in an amount of 0.1-1 part by mass based on the total shell mass, and
a lithium-containing composite in an amount of 0.1-1 part by mass based on the total shell mass.

The second aspect of the invention relates to a method for preparing the cathode active material for the lithium-ion battery having the structure comprising the core and the shell, the method comprising the steps of:
(a) preparing the core comprising the lithium nickel manganese cobalt oxide compound with a shape and size as required,
(b) preparing the shell comprising any one of or a mixture of materials selected from
   a carbon material in an amount of 0.1-1 part by mass based on the total shell mass,
   a reduced graphene oxide in an amount of 0.1-1 part by mass based on the total shell mass,
   a metal oxide in an amount of 0.1-1 part by mass based on the total shell mass, and
   a lithium-containing composite in an amount of 0.1-1 part by mass based on the total shell mass,
and
c) coating the shell obtained from step (b) onto a surface of the core obtained from step (a).

The third aspect of the invention relates to the cathode for the lithium-ion battery comprising the cathode active material according to the present invention, a binder, and a conductive material.

The fourth aspect of the invention relates to a method for preparing the cathode for the lithium-ion battery comprising the steps of:
preparing a mixture of the cathode active material according to the present invention, the binder, and the conductive material, and
coating the obtained mixture onto a substrate.

The present invention is aimed at enhancing the stability and efficiency of the lithium-ion battery by developing a cathode active material used to make the battery cathode by coating the core consisting of lithium nickel manganese cobalt oxide with the shell, which is a single material, or a multi-composite material selected from carbon material, reduced graphene oxide, metal oxide, and lithium-containing composite.

The cathode active material developed according to the present invention can reduce a charge transfer resistance (R_{ct}) of the lithium-ion battery, especially when compared to a battery using a conventional lithium nickel manganese cobalt oxide material.

The lithium-ion battery using the cathode active material having the structure comprising the core and the shell developed according to the present invention has good capacity and increased stability due to higher capacity retention, the battery cycle life thus can be extended.

### BRIEF DESCRIPTION OF THE DRAWINGS

FIG. 1 is images of the cathode active material according to the present invention obtained from a scanning electron microscope (SEM), wherein

FIG. 1(a) is a cross-sectional view of the cathode active material having the lithium nickel manganese cobalt oxide compound which is coated with a carbon material in an amount of 2.5% at a 15,000× magnification,

FIG. 1(b) is an image of the cathode active material having the lithium nickel manganese cobalt oxide compound which is coated with a carbon material in an amount of 2.5% at a 5,000× magnification,

FIG. 1(c) is a cross-sectional view of the cathode active material having the lithium nickel manganese cobalt oxide compound which is coated with a carbon material in an amount of 1% at a 15,000× magnification,

FIG. 1(d) is an image of the cathode active material having the lithium nickel manganese cobalt oxide compound which is coated with a carbon material in an amount of 1% at a 5,000× magnification,

FIG. 1(e) is a cross-sectional view of the cathode active material having the lithium nickel manganese cobalt oxide compound which is coated with a carbon material in an amount of 0.5% at a 15,000× magnification, and

FIG. 1(f) is an image of the cathode active material having the lithium nickel manganese cobalt oxide compound which is coated with a carbon material in an amount of 0.5% at a 5,000× magnification.

FIG. 2 is graphs showing the efficiency of the battery using the cathode comprising the active material according to the present invention, wherein

FIG. 2(a) shows the charge-discharge profile of the battery using the cathode comprising the active material having the lithium nickel manganese cobalt oxide compound which is coated with a carbon material in an amount of 2.5%,

FIG. 2(b) shows the capacity retention and the coulombic efficiency of the battery using the cathode comprising the active material having the lithium nickel manganese cobalt oxide compound which is coated with a carbon material in an amount of 2.5%,

FIG. 2(c) shows the charge-discharge profile of the battery using the cathode comprising the active material having the lithium nickel manganese cobalt oxide compound which is coated with a carbon material in an amount of 1%,

FIG. 2(d) shows the capacity retention and the coulombic efficiency of the battery using the cathode comprising the active material having the lithium nickel manganese cobalt oxide compound which is coated with a carbon material in an amount of 1%,

FIG. 2(e) shows the charge-discharge profile of the battery using the cathode comprising the active material having the lithium nickel manganese cobalt oxide compound which is coated with a carbon material in an amount of 0.5%, and

FIG. 2(f) shows the capacity retention and the coulombic efficiency of the battery using the cathode comprising the active material having the lithium nickel manganese cobalt oxide compound which is coated with a carbon material in an amount of 0.5%.

FIG. 3 is images of the cathode active material according to the present invention obtained from the scanning electron microscope, wherein

FIG. 3(a) is an image of the cathode active material having the lithium nickel manganese cobalt oxide compound which is coated with a carbon material in an amount of 1% at a 2,500× magnification,

FIG. 3(b) is an image of the cathode active material having the lithium nickel manganese cobalt oxide compound which is coated with a carbon material in an amount of 1% at a 5,000× magnification,

FIG. 3(c) is an image of the cathode active material having the lithium nickel manganese cobalt oxide compound which is coated with a reduced graphene oxide in an amount of 1% at a 2,500× magnification,

FIG. 3(d) is an image of the cathode active material having the lithium nickel manganese cobalt oxide compound which is coated with a reduced graphene oxide in an amount of 1% at a 5,000× magnification,

FIG. 3(e) is an image of the cathode active material having the lithium nickel manganese cobalt oxide compound which is coated with a lithium material as an electrolyte in an amount of 1% at a 2,500× magnification,

FIG. 3(f) is an image of the cathode active material having the lithium nickel manganese cobalt oxide compound which is coated with a lithium material as an electrolyte in an amount of 1% at a 5,000× magnification,

FIG. 3(g) is an image of the cathode active material having the lithium nickel manganese cobalt oxide compound which is coated with a metal oxide in an amount of 1% at a 2,500× magnification, and

FIG. 3(h) is an image of the cathode active material having the lithium nickel manganese cobalt oxide compound which is coated with a metal oxide in an amount of 1% at a 5,000× magnification.

FIG. 4 is a graph showing the charge-discharge profile of the battery using the cathode according to the present invention comprising the active material having the lithium nickel manganese cobalt oxide compound which is coated with a single material of reduced graphene oxide, lithium-containing composite, carbon material, and metal oxide each in an amount of 1% and a comparative battery.

FIG. 5 is graphs showing the capacity retention and the coulombic efficiency at different cycle numbers of the battery using the cathode comprising the active material according to the present invention, wherein

FIG. 5(a) shows the capacity retention and the coulombic efficiency of the battery using the cathode comprising the active material having the lithium nickel manganese cobalt oxide compound which is coated with a reduced graphene oxide in an amount of 1%,

FIG. 5(b) shows the capacity retention and the coulombic efficiency of the battery using the cathode comprising the active material having the lithium nickel manganese cobalt oxide compound which is coated with a lithium-containing composite in an amount of 1%,

FIG. 5(c) shows the capacity retention and the coulombic efficiency of the battery using the cathode comprising the active material having the lithium nickel manganese cobalt oxide compound which is coated with a carbon material in an amount of 1%, and

FIG. 5(d) shows the capacity retention and the coulombic efficiency of the battery using the cathode comprising the active material having the lithium nickel manganese cobalt oxide compound which is coated with a metal oxide in an amount of 1%.

FIG. 6 is a graph showing the charge-discharge profile of the battery using the cathode comprising the active material according to the present invention and the comparative battery.

FIG. 7 is graphs showing the capacity retention and the coulombic efficiency at different cycle numbers of the battery using the cathode comprising the active material according to the present invention and the comparative battery, wherein

FIG. 7(a) shows the capacity retention and the coulombic efficiency of the comparative battery,

FIG. 7(b) shows the capacity retention and the coulombic efficiency of the battery using the cathode comprising the active material having the lithium nickel manganese cobalt oxide compound which is coated with a carbon material in an amount of 1%,

FIG. 7(c) shows the capacity retention and the coulombic efficiency of the battery using the cathode comprising the active material having the lithium nickel manganese cobalt oxide compound which is coated with a mixture of carbon material and metal oxide in an amount of 1%, and

FIG. 7(d) shows the capacity retention and the coulombic efficiency of the battery using the cathode comprising the active material having the lithium nickel manganese cobalt oxide compound which is coated with the mixture of carbon material, metal oxide, and lithium material as an electrolyte in an amount of 1%.

FIG. 8 is a graph showing the capacity retention at different cycle numbers of the battery using the cathode comprising the active material according to the present invention and the comparative battery.

FIG. 9 is images of the cathode active material according to the present invention obtained from the scanning electron microscope, wherein

FIG. 9(a) is an overall image of the cathode active material having the lithium nickel manganese cobalt oxide compound, which is coated with the mixture of carbon material, reduced graphene oxide, metal oxide, and lithium-containing composite at a 1,500× magnification,

FIG. 9(b) is an image of the cathode active material having the lithium nickel manganese cobalt oxide compound, which is coated with the mixture of carbon material, reduced graphene oxide, metal oxide, and lithium-containing composite at a 5,000× magnification,

FIG. 9(c) is an image of the cathode active material having the lithium nickel manganese cobalt oxide compound, which is coated with the mixture of carbon material, reduced graphene oxide, metal oxide, and lithium-containing composite at a 10,000× magnification, and

FIG. 9(d) is a cross-sectional view of the cathode active material having the lithium nickel manganese cobalt oxide compound, which is coated with the mixture of carbon material, reduced graphene oxide, metal oxide, and lithium-containing composite at a 25,000× magnification, with a shell thickness of about 100 nm.

FIG. 10 is images of the cathode active material according to the present invention and a comparative cathode active material obtained from the scanning electron microscope, wherein

FIG. 10(a) shows a cross-sectional view of the comparative cathode active material at a 500× magnification,

FIG. 10(b) shows a cross-sectional view of the cathode active material having the lithium nickel manganese cobalt oxide compound, which is coated with the mixture of carbon material, reduced graphene oxide, metal oxide, and lithium-containing composite at a 500× magnification,

FIG. 10(c) shows a top view of the comparative cathode active material at a 1,000 magnification, and

FIG. 10(d) shows a top view of the cathode active material having the lithium nickel manganese cobalt oxide compound, which is coated with the mixture of carbon material, reduced graphene oxide, metal oxide, and lithium-containing composite at a 1,000× magnification.

FIG. 11 is graphs showing a structure analysis of the cathode active material according to the present invention and the comparative cathode active material obtained from an X-ray diffraction (XRD) analyzer, wherein

FIG. 11(a) is the structure analysis of the cathode active material having the lithium nickel manganese cobalt oxide compound, which is coated with the mixture of carbon material, reduced graphene oxide, metal oxide, and lithium-containing composite, and

FIG. 11(b) is the structure analysis of the comparative cathode active material.

FIG. 12 is a graph showing the charge-discharge profile of the battery using the cathode according to the present invention comprising the active material having the lithium nickel manganese cobalt oxide compound which is coated with the mixture of reduced graphene oxide, lithium-containing composite, carbon material, and metal oxide and the comparative battery.

FIG. 13 is a graph showing the resistance of the battery using the cathode according to the present invention comprising the active material having the lithium nickel manganese cobalt oxide compound which is coated with the mixture of reduced graphene oxide, lithium-containing composite, carbon material, and metal oxide and the comparative battery.

FIG. 14 is graphs showing the capacity retention and the coulombic efficiency at different cycle numbers of the battery using the cathode comprising the active material according to the present invention and the comparative battery, wherein

FIG. 14(a) shows the capacity retention and the coulombic efficiency of the battery using the cathode comprising the active material having the lithium nickel manganese cobalt oxide compound, which is coated with the mixture of carbon material, reduced graphene oxide, metal oxide, and lithium-containing composite, and

FIG. 14(b) shows the capacity retention and the coulombic efficiency of comparative battery.

FIG. 15 is a graph showing the capacity retention at different cycle numbers of the battery using the cathode according to the present invention comprising the active material having the lithium nickel manganese cobalt oxide compound which is coated with the mixture of reduced graphene oxide, lithium-containing composite, carbon material, and metal oxide and the comparative battery.

### DETAILED DESCRIPTION

Any aspects shown herein shall encompass the application to other aspects of the present invention as well, unless specified otherwise.

Any tools, devices, methods, materials, or chemicals mentioned herein, unless specified otherwise, mean the tools, devices, methods, materials, or chemicals generally used or practiced by a person skilled in the art, unless explicitly specified as special or exclusive tools, devices, methods, or chemicals for the present invention.

The terms “comprise(s)”, “consist(s) of”, “have/has”, “contain(s)”, and “include(s)” are open-end verbs. For example, any method which “comprises”, “consists of”, “has”, “contains”, or “includes” one component or multiple components or one step or multiple steps is not limited to only one component or one step or multiple steps or multiple components as specified, but also encompass components or steps that are not specified.

According to the present invention, the term “mechanofusion process” in a broad sense means the use of strong mechanical energy to trigger a chemical reaction and a mechanism between material particles to design and improve such material to give it a new property and higher quality.

According to the first aspect, the present invention is aimed at developing the cathode active material for the lithium-ion battery having the structure comprising the core and the shell, wherein the core comprises the lithium nickel manganese cobalt oxide compound and the shell comprises any one of or a mixture of materials selected from a carbon material in an amount of 0.1-1 part by mass based on the total shell mass, a reduced graphene oxide in an amount of 0.1-1 part by mass based on the total shell mass, a metal oxide in an amount of 0.1-1 part by mass based on the total shell mass, and a lithium-containing composite in an amount of 0.1-1 part by mass based on the total shell mass.

Preferably, a mass ratio of core to shell is in a range of 90-99:1-10, and more preferably in a range of 97-99:1-3.

According to the present invention, the lithium nickel manganese cobalt oxide compound has a formula Liₓ(Ni_{y}Mn_{z}Co_{1-y-z})O₂, whereby 0<x, y, z<1.

Particularly preferred is the lithium nickel manganese cobalt oxide compound with the ratio of nickel (Ni):manganese (Mn):cobalt (Co) of 8:1:1, i.e., having the formula Liₓ(Ni_{0.8}Mn_{0.1}Co_{0.1})O₂ (NMC 811).

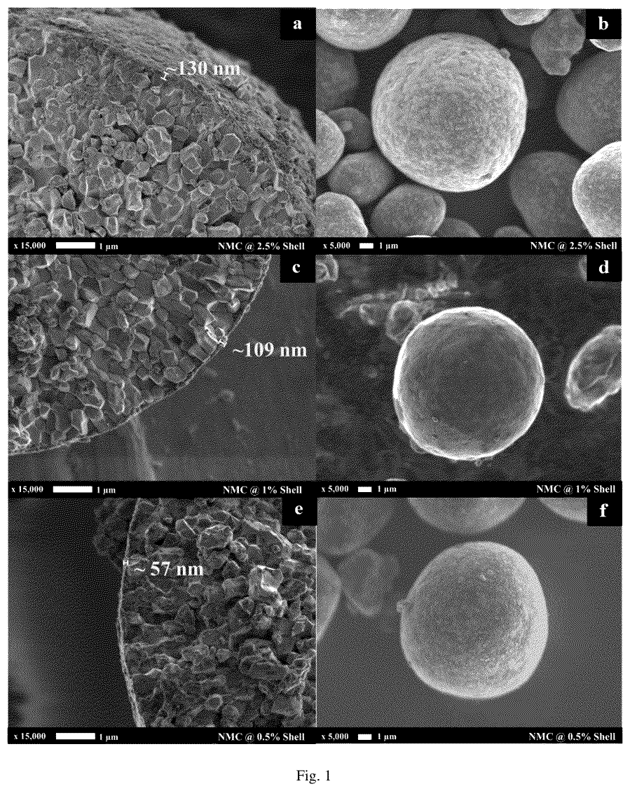

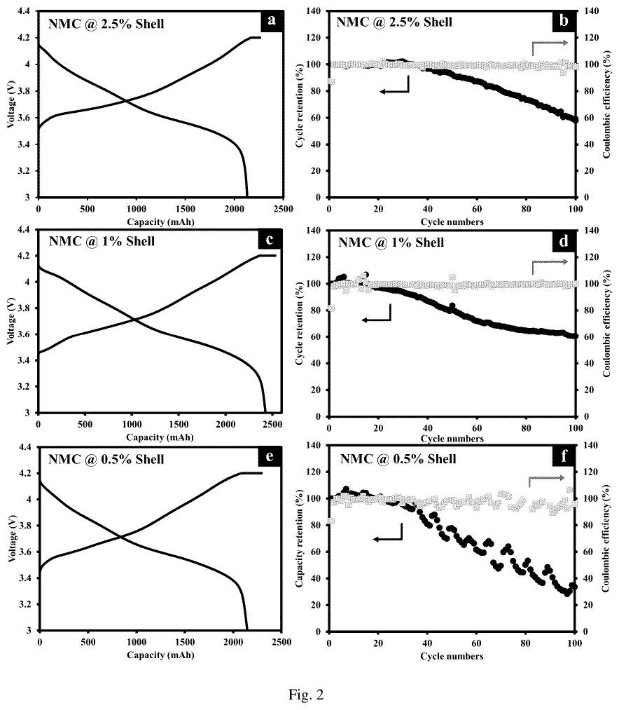

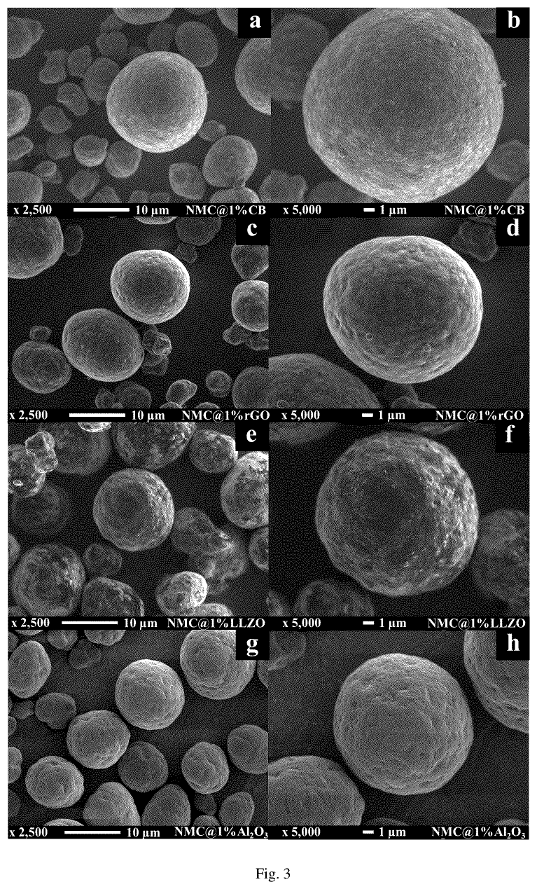

As an example, the core may have a particle size ranging from 8-14 μm and the shell may have a thickness ranging from 50-150 nm, preferably ranging from 80-120 nm, as shown in the test result in FIG. 1. Moreover, according to the test result, for example, as shown in FIG. 2, it was found that the shell with a thickness of about 100 nm has the highest efficiency with the highest capacity and capacity retention or stability.

The shell of the cathode active material according to the present invention can comprise one material or a mixture of materials selected from carbon material, reduced graphene oxide, metal oxide, and lithium-containing composite in an appropriate amount as specified above. The metal oxide effectively serves to prevent a reaction of electrolyte solution with the cathode active material as it has low sensitivity, while the carbon material and the reduced graphene oxide have high conductivity, thus increasing the battery capacity. Additionally, the lithium-containing composite can increase the compatibility between the shell and the electrolyte solution, thus enabling electron and ion to conveniently transfer between the cathode active material and the electrolyte solution.

Examples of carbon material which can be used with the present invention may be selected from a group consisting of carbon black, acetylene black, channel black, super P, furnace black, thermal black, carbon nanotube, nanocarbon, and a mixture thereof. Carbon nanotube and nanocarbon can be in many different shapes.

Examples of metal oxide which can be used with the present invention can be selected from a group consisting of aluminium oxide (Al₂O₃), silicon oxide (SiO₂), zirconium oxide (ZrO₂), selenium oxide (CeO₂), and a mixture thereof.

Examples of reduced graphene oxide which can be used with the present invention are graphene aerogel, 3D graphene, and graphene sponge.

Examples of lithium-containing composite which can be used with the present invention may be selected from a group consisting of lithium lanthanum zirconate (LLZO), lithium lanthanum oxide (Li₂ZrO₃), lithium tantalum oxide (LiTaO₃), lithium titanium oxide (Li₂TiO₃), and a mixture thereof.

The second aspect of the present invention relates to the method for preparing the cathode active material for the lithium-ion battery having the structure comprising the core and the shell.

The method for preparing the cathode active material according to the present invention comprises the steps of:
(a) preparing the core comprising lithium nickel manganese cobalt oxide compound with a shape and size as required,
(b) preparing the shell comprising any one of or a mixture of materials selected from
   a carbon material in an amount of 0.1-1 part by mass based on the total shell mass,
   a reduced graphene oxide in an amount of 0.1-1 part by mass based on the total shell mass,
   a metal oxide in an amount of 0.1-1 part by mass based on the total shell mass, and
   a lithium-containing composite in an amount of 0.1-1 part by mass based on the total shell mass,
and
(c) coating the shell obtained from step (b) onto the surface of the core obtained from step (a).

Preferably, the mass ratio of core to shell is in a range of 90-99:1-10, and more preferably in a range of 97-99:1-3.

The core comprising the lithium nickel manganese cobalt oxide compound which is suitable for the preparation of the cathode active material according to this aspect of the present invention is as described above, that is, the lithium nickel manganese cobalt oxide compound having the formula Liₓ(Ni_{y}Mn_{z}Co_{1-y-z})O₂, whereby 0<x, y, z<1. Particularly preferred is the ratio of nickel (Ni):manganese (Mn):cobalt (Co) of 8:1:1, i.e., having the formula Li(Ni_{0.8}Mn_{0.1}Co_{0.1})O₂ (NMC 811), wherein the core may have a particle size in a range of 8-14 μm.

Likewise, the shell suitable for the preparation of the cathode active material according to this aspect is as described above.

That is, examples of carbon material which can be used with the present invention may be selected from a group consisting of carbon black, acetylene black, channel black, super P, furnace black, thermal black, carbon nanotube, nanocarbon, and a mixture thereof. Carbon nanotube and nanocarbon can be in many different shapes.

Examples of metal oxide which can be used with the present invention can be selected from a group consisting of aluminium oxide, silicon oxide, zirconium oxide, selenium oxide, and a mixture thereof.

Examples of reduced graphene oxide which can be used with the present invention are graphene aerogel, 3D graphene, and graphene sponge.

Examples of lithium-containing composite which can be used with the present invention may be selected from a group consisting of lithium lanthanum zirconate, lithium lanthanum oxide, lithium tantalum oxide, lithium titanium oxide, and a mixture thereof.

The shell may have a thickness ranging from 50-150 nm, preferably ranging from 80-120 nm.

According to a preferred embodiment of the invention, step (c) is carried out using a mechanofusion process with a speed ranging from 2,500-5,000 rpm, which is a range of 1.4 to 100 Hz, a current ranging from 0.2 to 4.0 A, a motor power ranging from 0.5-1.5 kW, a temperature ranging from 20-50° C., and a period of time ranging from 10-60 minutes.

The method for preparing the cathode active material according to the present invention may further comprise step (d) of modifying the surface of the core to obtain a smooth surface prior to performing step (c).

Preferably, step (d) is carried out using the mechanofusion process with a speed ranging from 1,500-3,500 rpm, which is a range of 1.4 to 100 Hz, a current ranging from 0.2 to 4.0 A, a motor power ranging from 0.2-1.2 KW, a temperature ranging from 20-50° C., and a period of time ranging from 10-30 minutes.

The third aspect of the invention relates to a cathode for a lithium-ion battery comprising:
the cathode active material according to the present invention which has the structure and components as described above,
a binder, and
a conductive material.

As an example, the binder can be selected from a group consisting of polyvinylidene fluoride, poly (3,4-ethylenedioxythiophene), polytetrafluoroethylene, and a mixture thereof.

The conductive material can be selected from a group consisting of carbon black, acetylene black, super P, and a mixture thereof.

Preferably, a weight ratio of cathode active material to binder to conductive material is in a range of 90-98 to 1-5 to 1-5.

The fourth aspect of the invention relates to a method for preparing a cathode for a lithium-ion battery comprising the steps of:
preparing a mixture of the cathode active material according to the present invention, a binder, and a conductive material, and
coating the obtained mixture onto a substrate.

The binder and the conductive material for the preparation of the cathode active material mixture can be selected from the list above and a preferred substrate is aluminium.

Preferably, a weight ratio of cathode active material to binder to conductive material is in a range of 90-98 to 1-5 to 1-5.

Preferably, the preparation of the cathode active material, the binder, and the conductive material is carried out by mixing them in a presence of a solvent. As an example, the solvent is N-methylpyrrolidone. The obtained mixture of cathode active material, binder, and conductive material has a viscosity ranging from 4,000-10,000 Pa·s.

According to a preferred embodiment of the present invention, the mixture of cathode active material, binder, and conductive material is coated onto the substrate at a thickness ranging from 190-270 μm.

The substrate coated with the mixture of cathode active material, binder, and conductive material can be dried by heating at a temperature ranging from 100-180° C.

The cathode comprising the active material prepared according to the present invention is particularly preferred for the production of various types of lithium-ion battery, such as a cylindrical battery.

The present invention will now be described in more detail by citing the examples of the invention and the test results to be mentioned hereinafter with reference to the accompanying drawings, which do not limit the scope of the invention in any way.

### EXAMPLE

### 1. Preparation of the Cathode Active Material Having the Lithium Nickel Manganese Cobalt Oxide Compound Which Is Coated With a Single Material of Reduced Graphene Oxide, Lithium-Containing Composite, Carbon Material, and Metal Oxide

A process for preparing the active material started with preparing the shell material. The shell material, which is a metal oxide (aluminium oxide) and a lithium-containing composite, was subjected to a surface modification and a reduction of particle size using a ball mill.

The lithium nickel manganese cobalt oxide compound which is the core material was subjected to a surface modification to become a spherical material having a smooth surface by using the mechanofusion process to prepare for the coating of the shell material on the surface of the spherical core material. The preparation of the surface of the spherical core material was performed using a mechanofusion apparatus with a speed ranging from 1,500-3,500 rpm, a motor power ranging from 0.2-1.2 kW, and a temperature controlled to be in range of 20-50° C. This process was performed for a period of 10-30 minutes.

Then, the shell material was coated on the surface of the spherical core material, which was prepared using the mechanofusion process with a speed ranging from 2,500-5,000 rpm, a motor power ranging from 0.5-1.5 kW, and a temperature controlled to be in range of 20-50° C. This process was performed for a period of 10-60 minutes.

### 2. Preparation of the Cathode Active Material Having the Lithium Nickel Manganese Cobalt Oxide Compound Which Is Coated With the Mixture of Reduced Graphene Oxide, Lithium-Containing Composite, Carbon Material, and Metal Oxide

A process for preparing the active material started with preparing the shell mixture, which is the mixture of carbon material, reduced graphene oxide, metal oxide (aluminium oxide), and lithium-containing composite. The mass ratio of carbon was 0.1-1 to increase the conductivity of the active material. The mass ratio of reduced graphene oxide was 0.1-1 to increase the surface area and the conductivity of the active material. The mass ratio of metal oxide was 0.1-1 to protect the active material surface, which must be contacted with the electrolyte solution. The mass ratio of lithium-containing composite was in a range of 0.1-1 to increase the lithium-ion conductivity of the active material. The mixing of the shell mixture was performed using the ball mill until all substances become homogeneous upon visual observation.

The lithium nickel manganese cobalt oxide compound which is the core material was subjected to a surface modification to become a spherical material having a smooth surface by using the mechanofusion process to prepare for the coating of the shell mixture on such spherical material surface. The preparation of the spherical material surface was performed using the mechanofusion apparatus with a speed ranging from 1,500-3,500 rpm, a motor power ranging from 0.2-1.2 kW, and a temperature controlled to be in range of 20-50° C. This process was performed for a period of 10-30 minutes.

Then, the shell mixture was coated on the surface of the spherical core material prepared. The coating was performed using the mechanofusion process with a speed ranging from 2,500-5,000 rpm, a motor power ranging from 0.5-1.5 kW, and a temperature controlled to be in range of 20-50° C. This process was performed for a period of 10-60 minutes.

### 3. Preparation of the Cathode

The preparation of the cathode was performed by mixing 90-150 g polyvinylidene fluoride (PVDF), which serves as a binder, with 500-1,500 g N-methylpyrrolidone solution and stirring for 10-60 minutes under vacuum. Then, 90-150 g carbon material was added and stirred for 10-60 minutes under vacuum. Then, 1,500-2,500 g active material obtained from steps 1 and 2 above and 500-1,500 g N-methylpyrrolidone solution were added and stirred using an automatic mixer for a period of 6-24 hours, additional N-methylpyrrolidone solution was added so that the mixture has a viscosity ranging from 4,000-10,000 Pa·s. The mixture was then coated on an aluminium sheet which is a substrate using an automatic coater with a coating thickness of 190-270 μm and a drying temperature of 100-180° C.

### 4. Preparation of the Anode

The preparation of the anode was performed by mixing 30-50 g carboxymethyl cellulose, which serves as a binder, and 50-100 g ethanol in 500-1,000 g deionized water using the automatic mixer and stirring using a large paddle at a speed of 50-100 rpm and a small paddle at a speed of 2,000-5,000 rpm for 1-2 hours under vacuum. Then, 20-50 g carbon material, which serves as a conductive additive was added to the solution and stirred for 20-60 minutes under vacuum. Then, 50-100 g ethanol was added to the solution and stirred for 30-60 minutes under vacuum. Then, 1,500-2,000 g graphite material, which serves as an energy storage material, was added, and stirred for 1-2 hours under vacuum. Then, 50-100 g styrene-butadiene rubber, which serves as another binder, and 500-1,000 g deionized water were added and stirred for 1 hour under vacuum. Then, 500-1,000 g additional deionized water was added and stirred until homogeneous under vacuum. Then, such substance was coated on a copper sheet used as a substrate using the automatic coater with a coating thickness of 50-150 μm and a drying temperature of 100-130° C.

### 5. Battery Assembly

The cathode and the anode obtained from steps 3 and 4 were assembled into an 18650 cylindrical battery and a 2032 button battery.

The assembly of the 18650 cylindrical battery starts with calendering the cathode and the anode using an automatic calendering machine with a pressure of 2-10 tons to obtain the thickness of the cathode and the anode of 100-160 and 50-160 μm, respectively. Then, the cathode and the anode were cut into 5.5-6.0 cm in width and 55-70 cm in length using an automatic cutter. Then, the head portion of the cathode was welded with an aluminium strip using a welding machine and the end portion of the anode was welded with a nickel strip using a welding machine as well. Then, the electrodes were then wound together with a ceramic film between the two electrodes to prevent a short circuit using an automatic winding machine. The wound electrodes were then loaded into an 18650 cylindrical battery case. The case containing the electrodes was then subjected to a case grooving process. Then, a battery cap was welded to the electrodes inside the battery case before filling with 4-6 g electrolyte per one battery in an atmosphere-controlled chamber with the humidity and oxygen level lower than 0.1 ppm. The electrolyte solution used was lithium hexafluorophosphate which was dissolved in a mixture of 90-70% wt carbonate-based electrolyte solution, e.g., ethyl carbonate, dimethyl carbonate, and ethyl methyl carbonate and 10-30% wt fluorinate-based electrolyte solution. The battery was then charged using an automatic battery charger before wrapping the battery with a polyvinyl chloride (PVC) sheet at a temperature of 120-160° C. in a belt oven to obtain the exemplary 18650 cylindrical battery prepared from the cathode comprising the active material according to the present invention.

The assembly of the 2032 button battery starts with calendering the cathode using the calendering machine with a pressure of 1-5 tons to obtain the cathode thickness of 5-10 μm. Then, the cathode was cut to 1.2-1.6 cm in diameter using an automatic cutter. Then, the obtained cathode was spliced to a lithium foil which is the anode on the 2032 button battery case with a ceramic film between the two electrodes to prevent a short circuit before filling with 50-150 μl electrolyte per one battery in an atmosphere-controlled chamber with the humidity and oxygen level lower than 0.1 ppm. The electrolyte solution used was lithium hexafluorophosphate which was dissolved in a mixture of 90-70% wt carbonate-based electrolyte solution, e.g., ethyl carbonate, dimethyl carbonate, and ethyl methyl carbonate and 10-30% wt fluorinate-based electrolyte solution. Then, the battery was charged using an automatic battery charger to obtain the 2032 button battery prepared from the cathode comprising the active material according to the present invention.

### Test Results

The exemplary 18650 cylindrical battery comprising the cathode having the active material according to the present invention prepared above was tested for its efficiency using an electrochemical technique by comparing it to the comparative battery, which is a conventional NMC 811 battery (NMC-Pristine). The test result is described in connection with the accompanying drawings as follows.

### Study on the Effect of the Cathode Active Material Shell Thickness on the Battery Efficiency

FIG. 1 is the cathode active material having the lithium nickel manganese cobalt oxide compound which is coated with various amounts of carbon material. FIGS. 1(a) and 1(b) show the carbon amount of 2.5% by mass. FIGS. 1(c) and 1(d) show the carbon amount of 1% by mass. FIGS. 1(e) and 1(f) show the carbon amount of 0.5% by mass. The test result indicates that the active material of all carbon amounts has a particle size of approximately 8-14 μm with a spherical shape and a smooth surface. When splitting the particle in half, it was observed that a number of small particles of the lithium nickel manganese cobalt oxide material called primary particles agglomerated and became a larger secondary particle. Moreover, on the edge of the lithium nickel manganese cobalt oxide material, the carbon material was found to coat the surface as a thin film in an orderly arrangement and extensively cover the surface of the lithium nickel manganese cobalt oxide material. Different amounts of carbon material give different shell thicknesses, more carbon therefore means more shell thickness. It can be seen from the figure that the carbon amount of 2.5, 1.0, and 0.5% render the shell thickness of approximately 130, 109, and 57 nm, respectively.

FIG. 2 shows the test result of the battery efficiency in terms of charge-discharge profile, capacity retention, and coulombic efficiency of the battery using the cathode comprising the active material having the lithium nickel manganese cobalt oxide compound which is coated with the carbon material shell in various amounts. FIGS. 1(a) and 1(b) show the carbon amount of 2.5% by mass. FIGS. 1(c) and 1(d) show the carbon amount of 1% by mass. FIGS. 1(e) and 1(f) show the carbon amount of 0.5% by mass. The test result shows that the battery using the cathode comprising the active material having the lithium nickel manganese cobalt oxide core which is coated with the carbon shell in the amount of 1% by mass provides the highest capacity of over 2,400 mAh, whereas the exemplary battery using the cathode having the active material coated with the carbon material in the amount of 2.5 and 0.5% by mass provide a capacity of about 2,100 mAh. Moreover, the carbon amount used in coating also affects the capacity retention. The materials coated with the carbon amount of 2.5 and 1% provide better capacity retention of about 60%.

The change in the battery efficiency when the amount of carbon material is changed results from the different shell thickness. If the shell has greater thickness, for example, 130 nm (carbon material amount of 2.5%), it will lose the ability to retain the capacity as the amount of carbon material, which has no energy retention property, is too high or the ratio of the energy retention material (lithium nickel manganese cobalt oxide material) will be reduced. However, if the shell has lesser thickness, for example, 57 nm (carbon material amount of 0.5%), the electrolyte solution may permeate through a carbon particle gap, the reaction of lithium nickel manganese cobalt oxide material with the electrolyte solution thus cannot be prevented and the capacity rapidly fades during application. Hence, a suitable shell thickness is an extremely important factor for the battery efficiency improvement. According to this test, it was found that the shell thickness of about 100 nm is the most effective thickness to increase the battery efficiency.

### Study on the Effect of the Shell of the Cathode Active Material, Which Is a Single Material of Reduced Graphene Oxide, Lithium-Containing Composite, Carbon Material, and Metal Oxide on the Battery Efficiency

FIG. 3 is the cathode active material having the lithium nickel manganese cobalt oxide compound which is coated with a carbon material (FIGS. 3(a) and 3(b)), a reduced graphene oxide (FIGS. 3(c) and 3(d)), a lithium-containing composite (FIGS. 3(e) and 3(f)), and a metal oxide (FIGS. 3(g) and 3(h)) each in an amount of 1% by mass. It can be seen that all active materials have a particle size of 8-14 μm and a spherical shape. The active materials of which the shells are carbon material and reduced graphene oxide provide a smooth surface, whereas the shell which is lithium-containing composite and metal oxide provides a rougher surface.

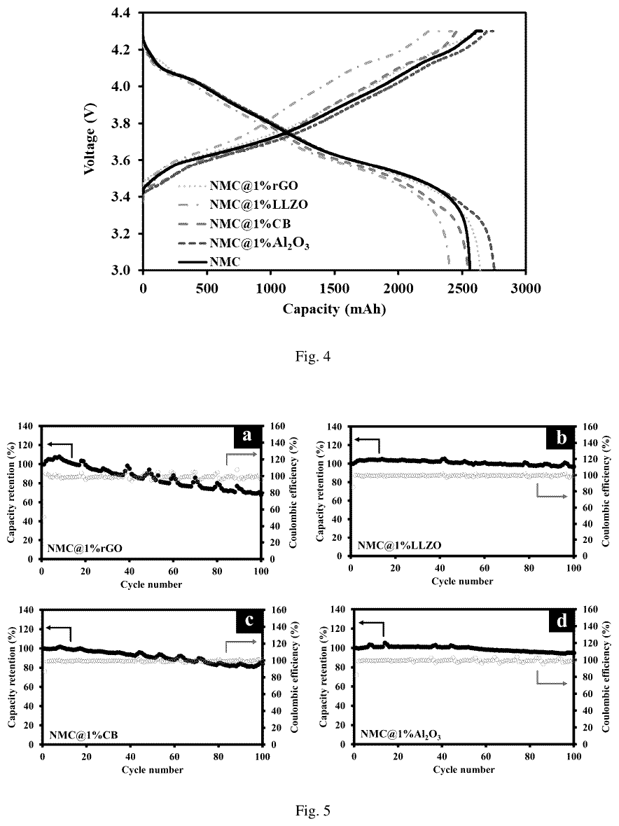

FIG. 4 shows the charge-discharge profile of the battery using the cathode according to the present invention comprising the active material having the lithium nickel manganese cobalt oxide compound which is coated with a single material of reduced graphene oxide, lithium-containing composite, carbon material, and metal oxide each in an amount of 1% by mass and the comparative battery. The test result shows that all battery capacities are in a range of 2,400-2,700 mA.

FIG. 5 is graphs showing the capacity retention and the coulombic efficiency at different cycle numbers of the battery using the cathode comprising the active material having the lithium nickel manganese cobalt oxide compound which is coated with a single material of reduced graphene oxide (FIG. 5(a)), lithium-containing composite (FIG. 5(b)), carbon material (FIG. 5(c)), and metal oxide (FIG. 5(d)) each in an amount of 1%. The test result shows that the batteries having the cathode active materials of which the shells are lithium-containing composite and metal oxide provide higher capacity retention than the batteries having the cathode active materials of which the shells are carbon material and reduced graphene oxide. This is because metal oxide compound is non-reactive; therefore, it can effectively prevent a reaction of the energy retention material with the electrolyte solution.

### Study on the Characteristics of the Cathode Material Coated With a Multi Composite Shell and Study on the Effect of the Cathode Active Material Shell, Which Is the Mixture of Reduced Graphene Oxide, Lithium-Containing Composite, Carbon Material, and Metal Oxide on the Battery Efficiency

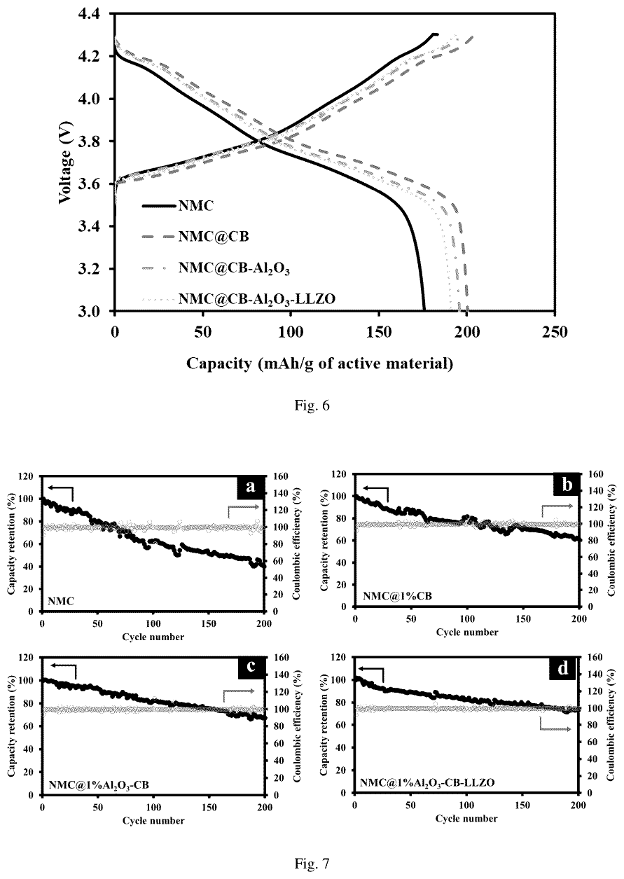

FIG. 6 shows the charge-discharge profile of the battery using the cathode comprising the active material having the lithium nickel manganese cobalt oxide compound which is coated with a carbon material, a mixture of carbon material and metal oxide (aluminium oxide), a mixture of carbon material, metal oxide (aluminium oxide) and lithium-containing composite, and the comparative battery of which the cathode has the active material containing the lithium nickel manganese cobalt oxide compound which is not coated. The test result shows that all battery capacities are in a range of 175-200 mA/g of the active material.

FIG. 7 shows the capacity retention and the coulombic efficiency at different cycle numbers of the battery using the cathode comprising the active material having the lithium nickel manganese cobalt oxide compound which is not coated (FIG. 7(a)), the active material having the lithium nickel manganese cobalt oxide compound which is coated with a carbon material (FIG. 7(b)), the active material having the lithium nickel manganese cobalt oxide compound which is coated with the mixture of carbon material and metal oxide (aluminium oxide) (FIG. 7(c)), the active material having the lithium nickel manganese cobalt oxide compound which is coated with the mixture of carbon material, metal oxide, and lithium-containing composite (FIG. 7(d)) at 1 C current. The test result shows that after 200 cycles, the capacity retentions were reduced differently when using the active material which was coated with different materials. The battery using the cathode which was not coated with the shell has 40% capacity retention, whereas the batteries using the cathode of which the active material was coated with the mixture of one, two or three optional materials according to the present invention have 61, 67, and 73% capacity retention, respectively.

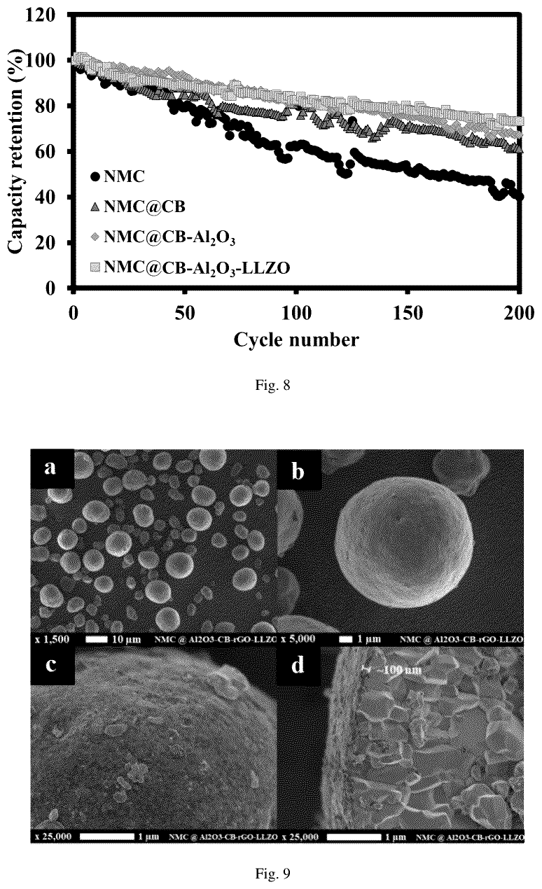

FIG. 8 shows the capacity retention at different cycle numbers of the comparative battery using the cathode comprising the active material having the lithium nickel manganese cobalt oxide compound which is not coated and the battery using the cathode comprising the active material according to the present invention having the lithium nickel manganese cobalt oxide compound which is coated with a carbon material, the mixture of carbon material and metal oxide (aluminium oxide), and the mixture of carbon material, metal oxide, and lithium-containing composite. The test result shows that the battery using the cathode having the active material, which is coated with a mixture of three materials, i.e., carbon material, metal oxide, and lithium-containing composite, provides higher capacity retention constant than the battery using the cathode having the active material which is coated with a single material and a mixture of two materials. This is because the carbon material increases the conductivity and the electron transportation, while the metal oxide is non-reactive and therefore effectively prevents a reaction of the energy retention material with the electrolyte solution. Also, the lithium as an electrolyte increases the lithium-ion dispersion. Using a mixture of multiple materials for the coating therefore extends the battery cycle life more effectively, compared to the lithium manganese cobalt oxide material which is not coated with the shell or only coated with a single material.

FIG. 9 shows the characteristic of the surface of the cathode active material having the lithium nickel manganese cobalt oxide compound which is coated with the mixture of carbon material, reduced graphene oxide, metal oxide, and lithium-containing composite. FIGS. 9(a), 9(b), and 9(c) show that the active material particle is a sphere with a relatively smooth surface and a size ranging from 8-14 μm. Upon surface observation, it was found that the surface is smooth and that the primary particles of the lithium nickel manganese cobalt oxide compound cannot be clearly seen. FIG. 9(d) shows the characteristic of the active material structure of which the core is encapsulated by the shell.

### Study on the Characteristic of the Cathode According to the Present Invention in Comparison With a Comparative Cathode

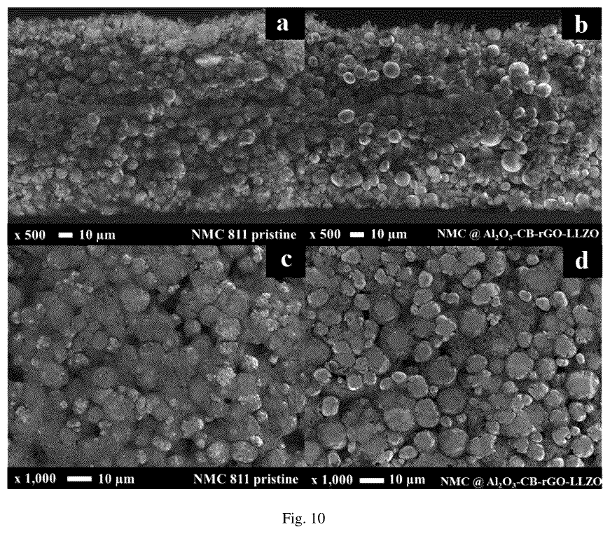

FIG. 10 shows the characteristic of the battery's cathode active material. FIG. 10(a) is the cross-sectional view of the cathode active material of the NMC 811 battery, which is a comparative example. FIG. 10(b) is the cross-sectional view of the cathode active material having the lithium nickel manganese cobalt oxide compound which is coated with the mixture of carbon material, reduced graphene oxide, metal oxide, and lithium-containing composite. FIG. 10(c) shows the top view of the cathode active material having the lithium nickel manganese cobalt oxide compound which is coated with the mixture of carbon material, reduced graphene oxide, metal oxide, and lithium-containing composite. FIG. 10(d) is the top view of the comparative cathode active material.

FIG. 10(a) shows that, in each active material particle, a spherical material having small carbon particles is inside the NMC material gap with an aluminium foil between two sides of the cathode and a polyvinylidene fluoride (PVDF) binder, which serves to bind the active material to the carbon material.

FIG. 10(b) shows that, in each active material particle, the spherical material having small carbon particles is inside the NMC material gap as well with an aluminium foil between two sides of the cathode and a polyvinylidene fluoride (PVDF) binder, which serves to bind the active material to the carbon material.

FIG. 10(c) shows the characteristic of the surface of the NMC 811 battery cathode, which is the comparative example. The image obtained from the SEM shows that the cathode consists of the spherical material having small carbon particles inside the NMC material gap in each particle. The polyvinylidene fluoride (PVDF) binder which serves to bind the NMC material to the carbon material was also observed.

FIG. 10(d) shows the characteristic of the cathode having the NMC 811 material prepared according to the invention as an active material. The image obtained from the SEM shows that the cathode consists of the spherical material having small carbon particles inside the energy retention material gap and the polyvinylidene fluoride binder as well.

According to FIGS. 10(a)-10(d), it can be concluded that the active material having the lithium nickel manganese cobalt oxide compound which is coated with the material according to the present invention does not have any negative effect on the battery cathode assembly and helps to prevent a direct contact of the active material with the electrolyte, which can reduce the occurrence of unwanted reaction.

### Study on the Structure of the Cathode Active Material According to the Present Invention in Comparison With the Comparative Cathode Active Material

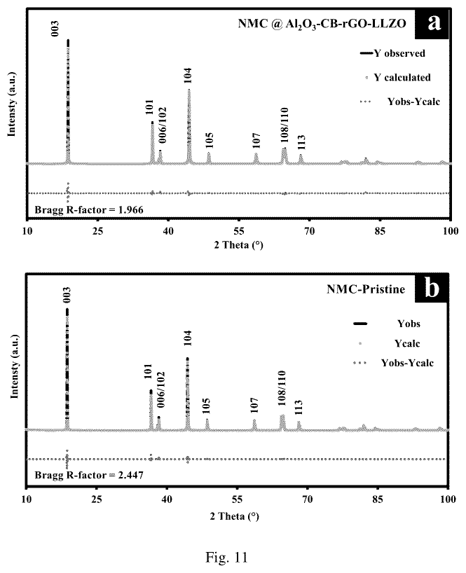

FIG. 11(a) shows the structure of the cathode active material according to the present invention having the lithium nickel manganese cobalt oxide compound which is coated with the mixture of carbon material, reduced graphene oxide, metal oxide, and lithium-containing composite. FIG. 11(b) shows the structure of the comparative cathode active material which is a conventional NMC material with no core-shell structure according to the present invention.

According to FIG. 11, the study through the X-ray diffraction analyzer (XRD) shows that both cathode active materials have the same R [symbol] structure with planes 003, 101, 006/102, 104, 105, 107, 108/110, and 113 as shown in the XRD graph. The study result obtained from the XRD graph analysis using the Rietveld refinement method to study the lattice parameters and the cation mixing is shown in Table 1.

Table 1 shows the parameter obtained from the analysis using the Rietveld refinement method.

TABLE 1

| | Cathode active material | Comparative |
|---|---|---|
| Lattice | according to the present | cathode active |
| parameter | invention | material |
| a (Å) | 2.87 | 2.87 |
| c (Å) | 14.21 | 14.20 |
| c/a | 4.95 | 4.95 |
| V (Å³) | 101.37 | 101.29 |

In Table 1, it can be seen that the lattice parameters of the cathode active material according to the present invention and the comparative example are not different, suggesting that the coating of the NMC material with the shell, which is the mixture of carbon material, reduced graphene oxide, metal oxide, and lithium-containing composite according to the present invention, does not change the NMC core structure and the c/a value of over 4.94 indicates an orderly arrangement of a layer structure.

### Study on the Charge-Discharge of the Battery Using the Cathode According to the Present Invention in Comparison With the Comparative Battery

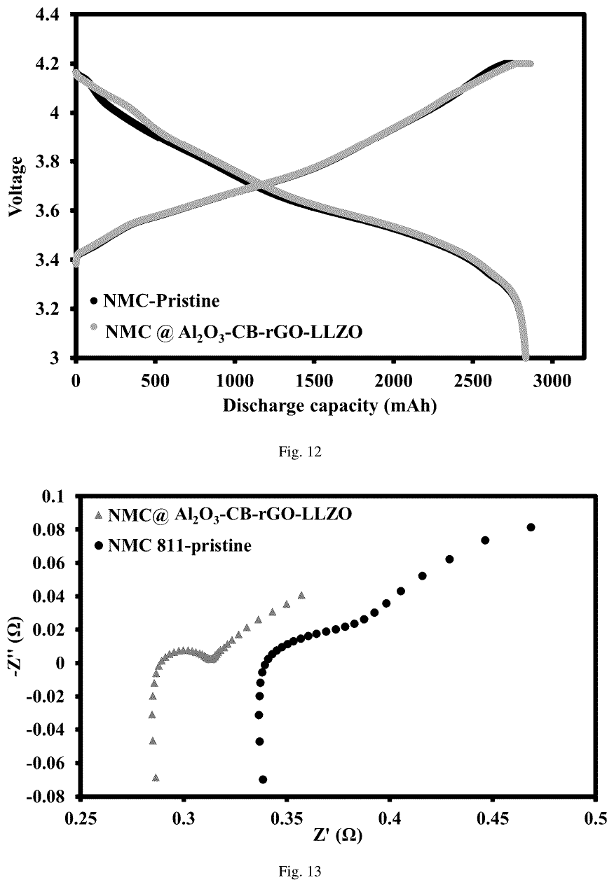

FIG. 12 shows the charge-discharge profile of the battery using the cathode according to the present invention comprising the active material having the lithium nickel manganese cobalt oxide compound which is coated with the mixture of reduced graphene oxide, lithium-containing composite, carbon material, and metal oxide and the comparative battery using the conventional NMC cathode. The figure shows that both batteries provide the same capacity of about 2,800 mAh, suggesting that the cathode having the active material of which the NMC core is coated with the mixture according to the present invention does not change the NMC structure and that the battery can still maintain a good capacity.

The capacity can still be maintained due to the shell mixture of the cathode active material which comprises the lithium as an electrolyte (such as LLZO), which can increase the lithium-ion dispersion, and the compatibility of the energy retention material and the electrolyte solution, as well as the carbon material which increases the conductivity and the electron transportation.

### Study on the Resistance of the Battery Using the Cathode According to the Present Invention in Comparison With the Comparative Battery

FIG. 13 shows the resistance of the battery using the cathode according to the present invention comprising the active material having the lithium nickel manganese cobalt oxide compound which is coated with the mixture of reduced graphene oxide, lithium-containing composite, carbon material, and metal oxide and the comparative battery using the conventional NMC cathode. Table 2 shows the resistance of the battery comprising the cathode according to the present invention and the comparative battery.

TABLE 2

| | Charge transfer |
|---|---|
| Battery example | resistance (R_{ct}) (Ω) |
| Comparative | 0.049 |
| According to the | 0.028 |
| invention | |

R_{ct} represents the charge and electron transfer resistance of the batteries which directly correlates with the active material. According to Table 2, it can be seen that the battery using the cathode according to the present invention has the R_{ct} of 0.028Ω which is two times lower than that of the comparative battery (the comparative battery R_{ct} is 0.049Ω), indicating that the active material according to the present invention can reduce the charge or electron transfer resistance.

### Study on the Stability and the Coulombic Efficiency of the Battery Using the Cathode According to the Present Invention in Comparison With the Comparative Batter

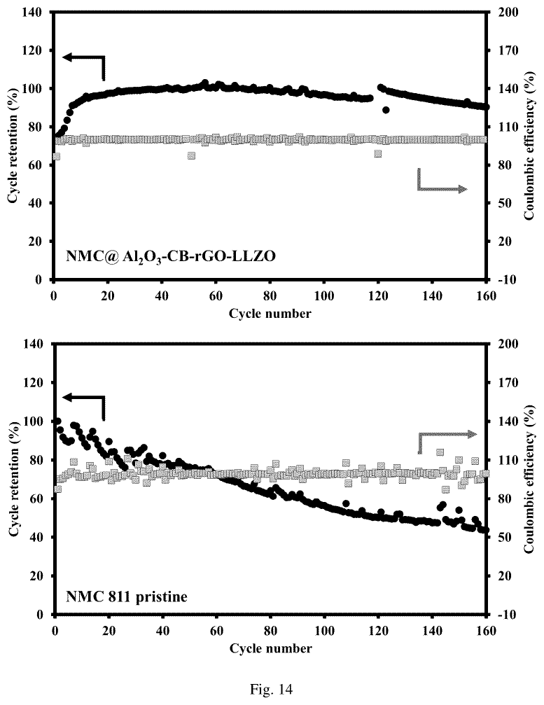

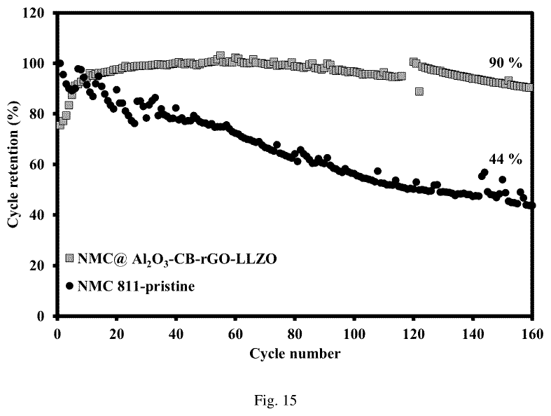

FIG. 14 shows the capacity retention and the coulombic efficiency at different cycle numbers of the battery using the cathode comprising the active material according to the present invention comprising the active material having the lithium nickel manganese cobalt oxide compound which is coated with the mixture of reduced graphene oxide, lithium-containing composite, carbon material, and metal oxide and the comparative battery.

FIG. 14(a) shows the capacity retention and the coulombic efficiency of battery comprising the cathode according to the present invention at 1 C current. The test result shows that after 160 cycles, the battery capacity was only slightly decreased which indicates the stability of the battery according to the invention, which uses the cathode active material which effectively reduces the electrolyte decomposition and the unwanted reaction of the electrodes with the electrolyte solution. Moreover, the coulombic efficiency was very good as it nearly reached 100% throughout 160 cycles.

FIG. 14(b) shows the capacity retention and the coulombic efficiency of comparative battery using the conventional NMC cathode at 1 C current. It was found that after 160 cycles, the capacity was clearly decreased.

FIG. 15 shows the capacity retention at different cycle numbers of the battery using the cathode according to the present invention comprising the active material having the lithium nickel manganese cobalt oxide compound which is coated with the mixture of reduced graphene oxide, lithium-containing composite, carbon material, and metal oxide and the comparative battery. The figure shows the stability of both batteries. According to the graph, it can be seen that the battery using the cathode according to the present invention provides high stability at the capacity retention of about 90% in the 160^{th} cycle, higher than the battery using the conventional NMC 811 electrode which has the capacity retention in the 160^{th} cycle of only 44%.

According to the above tests, it can be concluded that the cathode comprising the active material having the core-shell structure according to the present invention can reduce the battery degradation by 46%, compared to the battery using the conventional NMC 811 electrode, which is very important for the battery cycle life extension and suitable for commercial applications.

### Best Mode of the Invention

Best mode of the invention is as described in the detailed description of the invention.

1. A cathode active material for a lithium-ion battery having a structure comprising a core and a shell, wherein the core comprises lithium nickel manganese cobalt oxide compound and the shell comprises a mixture of at least two of materials selected from the group consisting of
a carbon material in an amount of 0.1-1 part by mass based on the total shell mass,
a reduced graphene oxide in an amount of 0.1-1 part by mass based on the total shell mass,
a metal oxide in an amount of 0.1-1 part by mass based on the total shell mass, and
a lithium-containing composite in an amount of 0.1-1 part by mass based on the total shell mass.

2. The cathode active material according to claim 1, wherein a mass ratio of core to shell is in a range of 90-99:1-10.

3. The cathode active material according to claim 1, wherein the mass ratio of core to shell is in a range of 97-99:1-3.

4. The cathode active material according to claim 1, wherein the lithium nickel manganese cobalt oxide compound has a formula Liₓ(Ni_{y}Mn_{z}Co_{1-y-z})O₂, whereby 0<x<1,and 0<y,z<1.

5. The cathode active material according to claim 1, wherein the lithium nickel manganese cobalt oxide compound has a formula Li(Ni_{0.8}Mn_{0.1}Co_{0.1})O₂.

6. The cathode active material according to claim 1, wherein the core has a particle size ranging from 8-14 μm.

7. The cathode active material according to claim 1, wherein the shell has a thickness ranging from 50-150 nm, preferably ranging from 80-120 nm.

8. The cathode active material according to claim 1, wherein the carbon material is selected from a group consisting of carbon black, acetylene black, channel black, super P, furnace black, thermal black, carbon nanotube, nanocarbon, and a mixture thereof.

9. The cathode active material according to claim 1, wherein the metal oxide is selected from a group consisting of aluminium oxide (Al₂O₃), silicon oxide (SiO₂), zirconium oxide (ZrO₂), selenium oxide (SeO₂), and a mixture thereof.

10. The cathode active material according to claim 1, wherein the lithium-containing composite is selected from a group consisting of lithium lanthanum zirconate (LLZO), lithium lanthanum oxide (Li₂LaO₃), lithium tantalum oxide (LiTaO₃), lithium titanium oxide (LizTiO₃), and a mixture thereof.

11. A method for preparing a cathode active material for a lithium-ion battery having a structure comprising a core and a shell, the method comprising the steps of:
(a) preparing the core comprising lithium nickel manganese cobalt oxide compound with a shape and size as required,
(b) preparing the shell comprising a mixture of at least two of the materials selected from the group consisting of
a carbon material in an amount of 0.1-1 part by mass based on the total shell mass,
a reduced graphene oxide in an amount of 0.1-1 part by mass based on the total shell mass,
a metal oxide in an amount of 0.1-1 part by mass based on the total shell mass, and
a lithium-containing composite in an amount of 0.1-1 part by mass based on the total shell mass,
and
(c) coating the shell obtained from step (b) onto a surface of the core obtained from step (a).

12. The method for preparing the cathode active material according to claim 11, wherein a mass ratio of core to shell is in a range of 90-99:1-10.

13. The method for preparing the cathode active material according to claim 11, wherein the mass ratio of core to shell is in a range of 97-99:1-3.

14. The method for preparing the cathode active material according to claim 11, wherein the lithium nickel manganese cobalt oxide compound has a formula Liₓ(Ni_{y}Mn_{z}Co_{1-y-z})O₂, whereby 0≤x≤1, 0<y, z<1.

15. The method for preparing the cathode active material according to claim 11, wherein the lithium nickel manganese cobalt oxide compound has the formula Li(Ni_{0.8}Mn_{0.1}Co_{0.1})O₂.

16. The method for preparing the cathode active material according to claim 11, wherein the core has a particle size ranging from 8-14 μm.

17. The method for preparing the cathode active material according to claim 11, wherein the carbon material is selected from a group consisting of carbon black, acetylene black, channel black, super P, furnace black, thermal black, carbon nanotube, nanocarbon, and a mixture thereof.

18. The method for preparing the cathode active material according to claim 11, wherein the metal oxide is selected from a group consisting of aluminium oxide, silicon oxide, zirconium oxide, selenium oxide, and a mixture thereof.

19. The method for preparing the cathode active material according to claim 11, wherein the lithium-containing composite is selected from a group consisting of lithium lanthanum zirconate, lithium lanthanum oxide, lithium tantalum oxide, lithium titanium oxide, and a mixture thereof.

20. The method for preparing the cathode active material according to claim 11, wherein in step (c), the shell is coated at a thickness ranging from 50-150 nm, preferably ranging from 80-120 nm.

21. The method for preparing the cathode active material according to claim 11, wherein step (c) is carried out using a mechanofusion process with a speed ranging from 2,500-5,000 rpm, a motor power ranging from 0.5-1.5 kW, a temperature ranging from 20-50° C., and a period of time ranging from 10-60 minutes.

22. The method for preparing the cathode active material according to claim 11 further comprises step (d) of modifying the surface of the core to obtain a smooth surface prior to performing step (c).

23. The method for preparing the cathode active material according to claim 22, wherein step (d) is carried out using the mechanofusion process with a speed ranging from 1,500-3,500 rpm, a motor power ranging from 0.2-1.2 kW, a temperature ranging from 20-50° C., and a period of time ranging from 10-30 minutes.

24. A cathode for a lithium-ion battery comprising:
the cathode active material according to claim 1,
a binder, and
a conductive material.

25. The cathode according to claim 24, wherein the binder is selected from a group consisting of polyvinylidene fluoride, poly(3,4-ethylenedioxythiophene), polytetrafluoroethylene, and a mixture thereof.

26. The cathode according to claim 24, wherein the conductive material is selected from a group consisting of carbon black, acetylene black, super P, and a mixture thereof.

27. The cathode according to claim 24, wherein a weight ratio of cathode active material to binder to conductive material is in a range of 90-98 to 1-5 to 1-5.

28. A method for preparing a cathode for a lithium-ion battery comprising the steps of:
preparing a mixture of the cathode active material according to claim 1, a binder, and a conductive material, and coating the obtained mixture onto a substrate.

29. The method for preparing the cathode according to claim 28, wherein the binder is selected from a group consisting of polyvinylidene fluoride, poly(3,4-ethylenedioxythiophene), polytetrafluoroethylene, and a mixture thereof.

30. The method for preparing the cathode according to claim 28, wherein the conductive material is selected from a group consisting of carbon black, acetylene black, super P, and a mixture thereof.

31. The method for preparing the cathode according to claim 28, wherein the substrate is aluminium.

32. The method for preparing the cathode according to claim 28, wherein a weight ratio of cathode active material to binder to conductive material is in a range of 90-98 to 1-5 to 1-5.

33. The method for preparing the cathode according to claim 28, wherein the preparation of the mixture of cathode active material, binder, and conductive material is carried out by mixing in a presence of a solvent.

34. The method for preparing the cathode according to claim 33, wherein the solvent is N-methylpyrrolidone.

35. The method for preparing the cathode according to claim 28, wherein the obtained mixture of cathode active material, binder, and conductive material has a viscosity ranging from 4,000-10,000 Pa·s.

36. The method for preparing the cathode according to claim 28, wherein the mixture of cathode active material, binder, and conductive material is coated onto the substrate at a thickness ranging from 190-270 μm.

37. The method for preparing the cathode according to claim 28 further comprises a step of drying the coated substrate.

38. The method for preparing the cathode according to claim 37, wherein the substrate is dried by heating at a temperature ranging from 100-180° C.

39. A lithium-ion battery comprising the cathode according to claim 24 and an electrolyte including a mixture of 90-70% wt carbonate-based electrolyte solution and 10-30% wt fluorinate-based electrolyte solution.

40. The lithium-ion battery according to claim 39 which is a cylindrical battery.

41. The cathode active material according to claim 1, wherein the shell comprises a mixture of
a carbon material in an amount of 0.1-1 part by mass based on the total shell mass,
a metal oxide in an amount of 0.1-1 part by mass based on the total shell mass,
a lithium-containing composite in an amount of 0.1-1 part by mass based on the total shell mass, and
optionally, a reduced graphene oxide in an amount of 0.1-1 part by mass based on the total shell mass.

42. The method for preparing the cathode active material according to claim 12, wherein the shell of step (b) comprises a mixture of
a carbon material in an amount of 0.1-1 part by mass based on the total shell mass,
a metal oxide in an amount of 0.1-1 part by mass based on the total shell mass,
a lithium-containing composite in an amount of 0.1-1 part by mass based on the total shell mass, and
optionally, a reduced graphene oxide in an amount of 0.1-1 part by mass based on the total shell mass.
